(19) United States
(12) Patent Application Publication
(10) Pub. No.: US 2003/0212901 A1
(43) Pub. Date: Nov. 13, 2003

(54) Security enabled network flow control

(76) Inventors: Manav Mishra, Hillsboro, OR (US); Puqi Tang, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/145,379

(22) Filed: May 13, 2002

(51) Int. Cl. H04L 9/00

(52) U.S. Cl. 713/200

(57) ABSTRACT

A flow control system may include a network device having a plurality of network interfaces for receiving and transmitting packets of data, a control element associated with the network device to receive from a security endpoint a security information event which includes rules for decrypting or routing an encrypted packet, and a routing element associated with the network device to route packets based on the rules provided in the security information event.

### TECHNICAL FIELD

Certain illustrative embodiments described herein relate to devices and processes for providing access control in network communications and, more specifically, to systems for controlling transmission of encrypted data.

### BACKGROUND

Networks of computers such as intranets, local and wide area networks, and the Internet exchange information in “packets.” A packet includes data such as files and programs and can also include a header that contains information that identifies the packet and indicates its origin and destination. The header can further include network protocol identifiers and the version number of the protocol that is to be used to route the information through the network. The header can also contain information identifying the port on the source computer from which the packet was sent and the port on the destination computer to which the packet is to be sent.

Computers connected to the Internet can be given either a static or dynamic Internet Protocol, or IP, address. Packets exchanged through the Internet accordingly often include an IP source address, an IP destination address, and an IP protocol identifier in addition to source and destination port information.

There is a need in computer networks, including the Internet, to control the exchange of packets in order to prevent the unauthorized disclosure, modification, or execution of data and programs on a networked computer. In packet-switching networks, this is often accomplished through the use of an Access Control List, or ACL, that contains filter rules which indicate whether a packet should be accepted or dropped based on the identifiers included in the packet header.

In recent years, secure protocols such as Internet Security Protocol (IPsec) have been implemented. Some security protocols encrypt both the packet and one or more fields in the packet header (e.g., inner ports, inner IP addresses and protocol numbers). The encryption of the packet header information complicates enforcement of filter rules because a standard ACL enforcement device (e.g. a firewall) is able only to query and evaluate clear, or unencrypted, packet headers.

Security protocols can also complicate provision of packet-related services such as load balancing. Load balancing involves the distribution of packet traffic amongst various ports and/or platforms to minimize data flow congestion and maximize system throughput. If the routing element is not able to interpret the packets and/or packet headers, the packet sorting and load balancing typically occurs at a relatively coarse granularity. Conversely, if the routing element can read the inner header of the packet, the packet load can be distributed at a much finer granularity.

### DESCRIPTION OF DRAWINGS

FIG. 1 is a block diagram of a gateway that routes IPsec encrypted packet headers in response to a SITP information event.

FIG. 2A is a block diagram showing further aspects of the SITP information event depicted in FIG. 1 under a first trust model.

FIG. 2B is a block diagram showing, further aspects of the SITP information event depicted in FIG. 1 under a second trust model.

FIG. 3 is a block diagram of an exemplary graph of filter chains generated from the SITP information event of FIG. 2B.

FIG. 4 is a process diagram depicting an illustrative SITP session between a gateway and an IPsec host.

Like reference symbols in the various drawings indicate like elements.

### DETAILED DESCRIPTION OF ILLUSTRATIVE EMBODIMENTS

A system for controlling the flow of encrypted packets can be realized by, for example, transmitting a Security Information Transport Protocol (SITP) information event to a router or other gateway that uses the security information embedded in the information event to filter, forward, load balance, etc. the incoming and outgoing packets. In a first trust model the SITP information event includes i) a 4-tuple that corresponds to the four clear packet headers in an IPsec encrypted packet, and ii) a set of associated inner IP addresses, protocols and ports. The SITP information event, in effect, instructs the gateway that any encrypted packets whose headers correspond to the 4-tuple should have the associated inner IP address and port addresses in its encrypted part, i.e., the inner header used inside the IPsec tunnel. Such an embodiment reflects a trust model wherein the border gateway trusts the local IPsec endpoint to provide the mapping from the outer packet header info to the inner packet header info provided by the endpoint. In a second trust model, the SITP information event includes i) a 4-tuple that corresponds to the four clear packet headers in an IPsec encrypted packet, and ii) a set of associated decryption keys and algorithms. In such an embodiment, the SITP information event instructs the gateway to decrypt packets whose headers correspond to the 4-tuple according to the associated decryption keys and algorithms, after which the gateway can filter and/or route the packet as it would a clear packet. This embodiment reflects a trust model in which the IPsec end point trusts the border gateway and is willing to share the session key of the encrypted data flow with the gateway in order to obtain a service (e.g. transmission past a firewall, higher level of QoS, etc.) from the gateway.

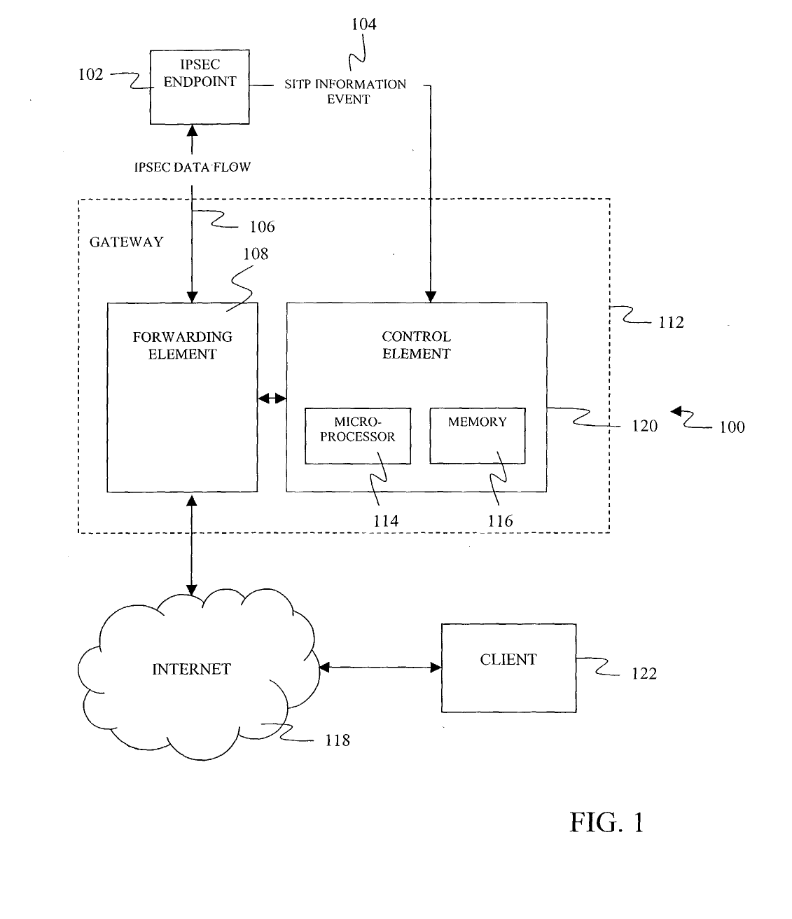

FIG. 1 shows an illustrative network architecture 100 for filtering, forwarding, and/or balancing packets with encrypted packet headers. The IPsec endpoint 102 can be a virtual private network (“VPN”) gate server. The VPN server can be networked with a plurality of local networked computers, sometimes referred to as an intranet, in which case there would be a multiplicity of local user endpoints. The client 122 can be a remote endpoint accessed via a public domain such as the Internet 118. The VPN can include the client 122 and can further include additional remote clients accessed via public domains such as the Internet 118. The client 122 shown in FIG. 1 is connected to the local IPsec endpoint 102 through the forwarding element 108 in a network device, which in this embodiment is an open network (ON) gateway 112, which can include one or more routers. The forwarding element 108 can be a combination of hardware (including memory and microprocessor elements) and software configured to forward packets. The forwarding element 108 can include or be connected to one or more Internet hosts which provide a connection to the Internet. The forwarding element 108 is connected, or networked, with a control element 120 that includes one or more networked computers having memory 116 and microprocessor 114. In a typical ON router construction, there are multiple forwarding elements 108. Generally, there is at least one forwarding element connected to the Internet host(s) 118 and at least one forwarding element connected to the IPsec endpoint 102. A plurality of remote clients can be connected to the VPN through the Internet 118 or other public network.

Packets in the IPsec data flow 106 can have headers that include multiple fields or parameters. Typical header fields are the outer source IP address (OSIP), the outer destination IP address (ODIP), the outer protocol (Oproto), the ESP protocol (ESPProto), the inner source IP address (ISIP), the inner destination IP address (IDIP), the inner protocol (IProto), the source port (SPort), the destination port (DPort), and the security payload index (SPI). Some or all of the inner packet header fields are encrypted in the IPsec ESP mode.

Data can be transmitted in various encrypted modes, including tunneling mode and transport mode. Tunneling mode is an ESP mode that encrypts an entire inner IP packet including the inner IP header and data, whereas transport mode is an ESP mode that encrypts packet headers above the transport layer and the data contents of a packet, and leaves the original IP addresses in plaintext. In certain tunneling mode implementations, a packet's inner source IP address (ISIP), the inner destination IP address (IDIP), the inner protocol (IProto), the source port (SPort), and the destination port (DPort) are encrypted are encrypted, while the remainder of the header parameters are clear, or unencrypted.

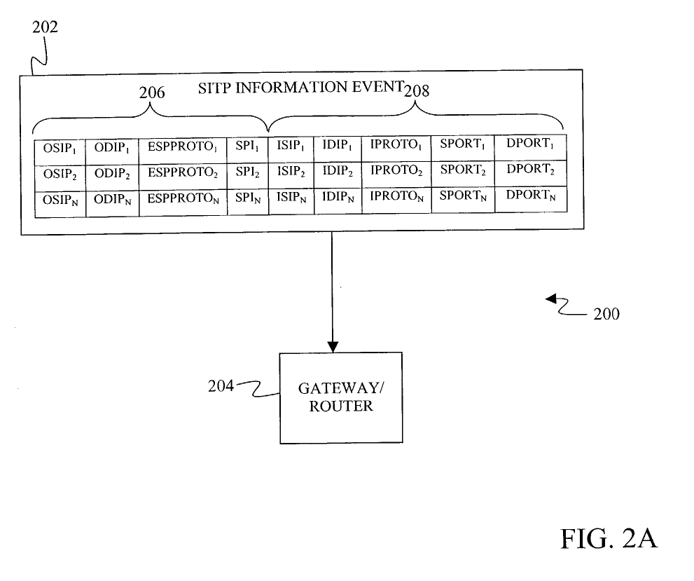

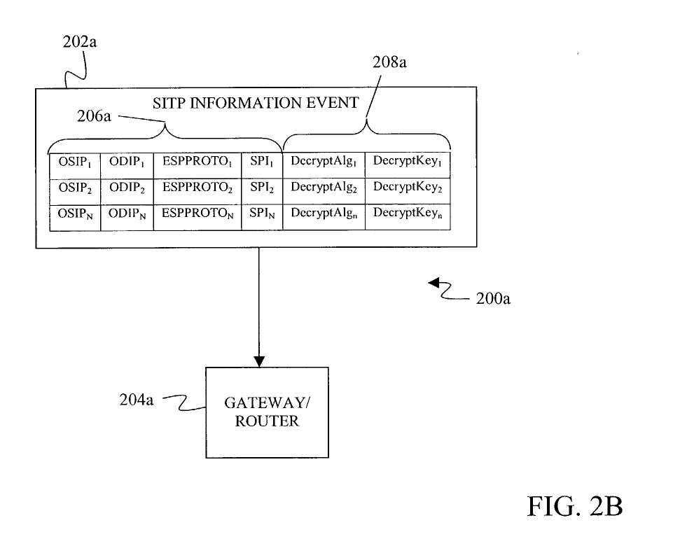

FIG. 2A depicts a first trust model 200 in which a SITP information event 202 can include IPsec header information 206 that consists of the 4-tuple OSIP, ODIP, ESPProto, and SPI. The SITP information event 202 can further include flow information 208 that consists of the 5-tuple ISIP, IDIP, IProto, SPort, and DPort. This represents a mapping from the outer 4-tuples (in clear text) to the inner 5-tuples (in cipher text). The identifiers or parameters set forth in any tuple can be precise values or they can include wildcards or a value range. For example, IDIP can be 144.34.*.2, which will correspond to inner destination IP addresses 144.34.954.2, 144.34.123.2, etc. The IPsec header information 204 can have “n” IPsec mappings (labeled 1, 2, through n). Likewise, the flow information can include 5-tuples specifying “n” destination mappings.

Referring now to FIG. 2B, the SITP information event 202a in a second trust model 200a includes IPsec header information 206a that consists of “n” entries of the 4-tuple OSIP, ODIP, ESPProto, and SPI. The SITP information event 202a can further include flow information 208a that includes decryption keys (DecryptKey) and decryption algorithms (DecryptAlg) for “n” security mappings. As noted above in connection with the first trust model, the identifiers or parameters set forth in any tuple can be precise values or they can include wildcards or a value range.

The foregoing techniques can be integrated with firewall services. As an illustration, firewall integration will be described in connection with the second trust model 200a.

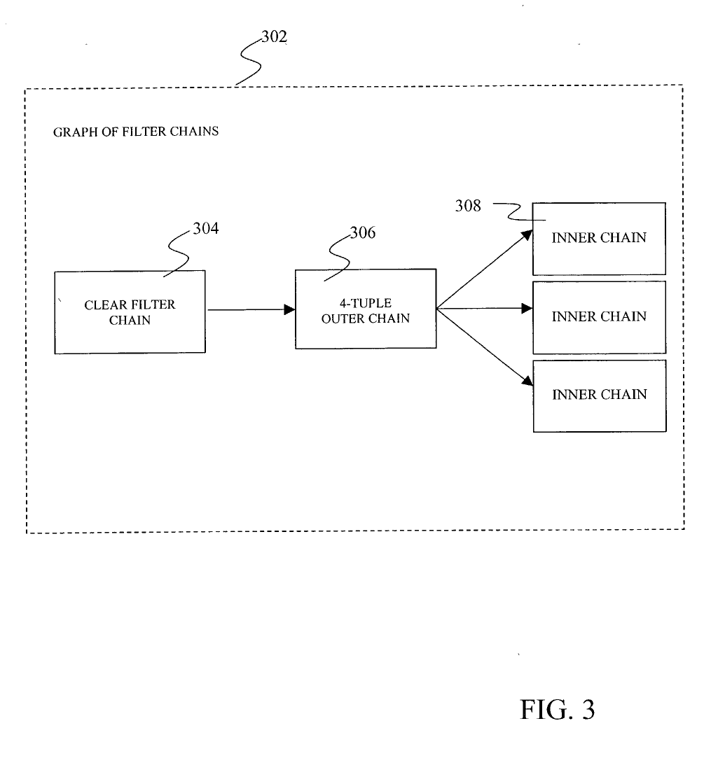

The control element 120 or other element embedded in or associated with the gateway 112 can incorporate the SITP information event 104 and an ACL into a graph of filter chains such as those depicted in FIG. 3. The filter chains can contain a series of entries, each entry including a 4-tuple and its associated decryption key and decryption algorithm. A forwarding element 108 or other network component can implement the filter chains by querying the fields OSIP, ODIP, ESPProto, and SPI in a received encrypted packet's header and sequentially determining whether the packet header corresponds to any entry in the filter chain. If a matching entry is found, the packet is decrypted according to the decryption key and decryption algorithm set forth in the filter chain entry. If no matching entry is found, the forwarding element 108 can perform a desired default action, such as dropping the packet or decrypting according to a default algorithm and/or key. After decryption, the packet can be forwarded pursuant to the standard RIB embedded in the forwarding element.

An exemplary graph of filter chains 302 is shown in FIG. 3. The graph of filter chains can include a clear filter chain 304 that has a plurality of rules to be applied to clear packet headers. The first rule in the clear filter chain 304 can provide that any encrypted packets, such as IPsec encrypted packets, be evaluated by an outer 4-tuple chain 306. The outer chain 4-tuple can include OSIP, ODIP, OProto, and SPI.

In the second trust model 200a, packets having headers that correspond to, or match, the 4-tuple values (or ranges of values), can be first decrypted and then its inner part can be evaluated by an inner chain 308 that preferably includes either the 3-tuple ESPProto, DPort, and SPort (in transport mode) or the 6-tuple ESPProto, ISIP, IDIP, IProto, DPort, and SPort (in tunneling mode). The inner filter rule tables 308 can include both types filter rules. The inner filter chains 308 also include an action such as ACCEPT or DROP that is to be carried out on the packets whose inner headers correspond to the values or ranges of values specified in the inner filter rule tables, or chains (an IPsec ESP mode packet has an inner header and an outer header; the former is assembled by the host and the second is constructed by the device that is providing security services).

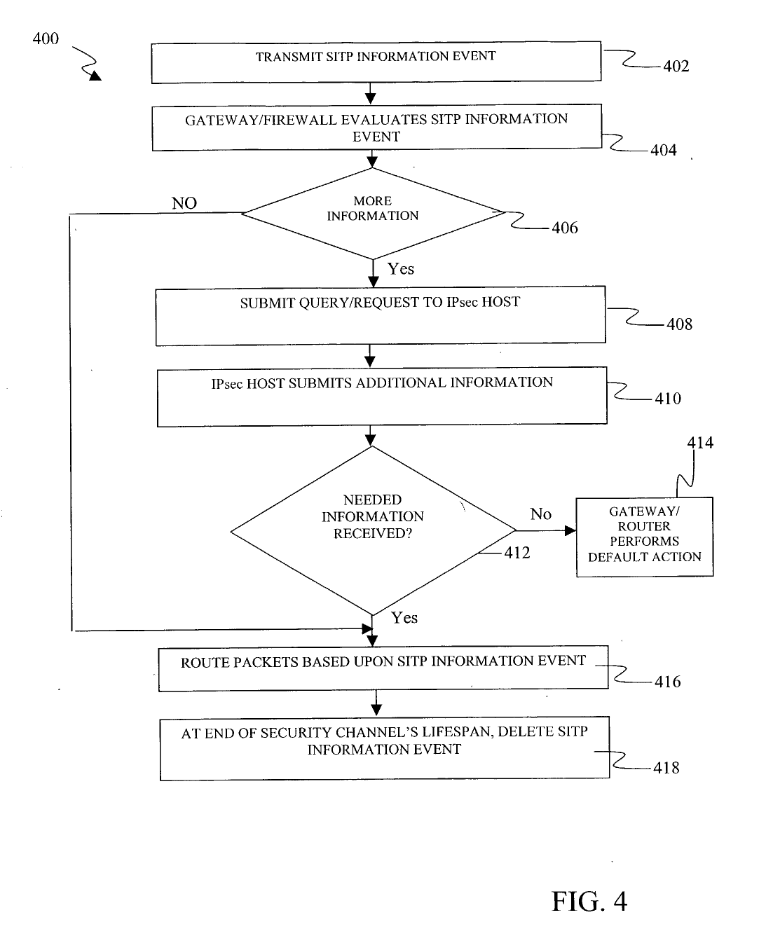

FIG. 4 depicts the process flow of an illustrative session between an IPsec host and an gateway or firewall. In this exemplary embodiment, the IPsec host transmits (402), for example, the SITP information event 202/202a to a gateway 204/204a. The gateway 204/204a can then evaluate (406) whether the information provided complies with, for example, policies specified by a network administrator. Such a policy may provide that the gateway is not permitted to route packets pursuant to the first trust model discussed above. Rather, the policy may dictate that the gateway must decrypt all encrypted packets and evaluate them against, for instance, a firewall rule table. In another example, the gateway may not permit packets to be transmitted in tunneling mode. Rather, the gateway may require the full 5-tuple typically provided in transport mode. If more information is required, the gateway 204/204a may then submit (408) a query or request to the IPsec host for the needed information. If the host responds with the additional information (410), such as an additional SITP information event, the gateway 204/204a may route the packet as specified in the information event (416). If the IPsec host fails to provide the requested information, the gateway 204/204a may perform a default action, such as dropping the affected packets (414). At the termination of the security channels' lifespan, the IPsec host may transmit a delete call to the gateway 204/204a pursuant to which the gateway may delete the information provided via the SITP information event(s), such as session keys and algorithms.

The foregoing techniques can be customized to the needs of particular network, implemented in a wide variety of network architectures, and used to effectively communicate security information pursuant to any number of security protocols. Security information defined by other security protocols can be readily communicated between or amongst hosts, gateways, routers, switches, firewalls, clients, etc. An almost limitless number of additional implementations may be dictated by particular network architecture(s), security protocols, and other design parameters.

Various trust models can be implemented. In the trust model shown in FIGS. 2A and 2B, either decryption information or destination information is forwarded to the control element. However, in other trust models, decrypted packet header information can be provided to the control element or forwarding element, which alleviates the need to derive inner filters that contain decryption information. Yet another trust model involves transmitting both the information of trust model 200 and the information of trust model 200a to the gateway, which decrypts packets according to the provided decryption keys only when necessary. Many other trust models can be readily implemented pursuant to the teachings set forth herein.

Tuples having different widths and different constituent parameters can be selected for use at each layer of the filter chain; there is no rigid requirement that the specified tuple parameters be present in each filter layer.

Similarly, it will be apparent to those skilled in the art that the specific protocols described above, and their particular sequencing, are merely illustrative embodiments selected for a particular network architecture and security protocol. Unless specifically stated otherwise, the steps of each protocol can be performed in a different sequence.

While the above description has been directed primarily to gateways and firewalls, those skilled in the art will understand that the above techniques can be applied to other security aware services such as traffic engineering, QoS, load balancing, etc.

The foregoing proposed modifications will be understood as merely illustrative by those skilled in the art. It will be understood that various modifications may be made without departing from the spirit and scope of the invention. Accordingly, other embodiments are within the scope of the following claims.

Aspects of the invention provide for one or more of the following advantages. In selected embodiments, the invention provides a system and method that integrates security information with an RIB. In certain embodiments, the security enabled gateway can effectively perform packet-level services on encrypted data flows, including load balancing. In some embodiments, the IPsec aware classification circuit greatly enriches the programmability of ON gateways and routers. In still other embodiments, the foregoing techniques can be used to provide IPsec friendly services, such as firewall and QoS services, to IPsec based networks such as VPNs.

What is claimed is:

1. A flow control system in a network device having a plurality of network interfaces for receiving and transmitting packets of data comprising:
a control element associated with the network device to receive from a security endpoint a security information event, said security information event including rules for decrypting or routing an encrypted packet; and
a routing element associated with the network device to route packets based on the rules provided in the security information event.

2. The system of claim 1, wherein the network device is a gateway, router, or switch.

3. The system of claim 1, wherein the control element and routing element are part of the network device.

4. The system of claim 3, including a network device communicatively coupled to a public network.

5. The system of claim 1, wherein the network device is part of an open network architecture.

6. The system of claim 1, wherein the network device, control element and routing element reside on separate platforms.

7. The system of claim 1, wherein the security information event includes a 4-tuple specifying outer addresses and security information carried in a clear portion of a packet header.

8. The system of claim 1, wherein the packets are encrypted pursuant to a security information transport protocol.

9. The system of claim 1, wherein the network device provides firewall services.

10. The system of claim 1, wherein the security information event is compromised of information received in multiple transmissions.

11. The system of claim 1, wherein the security information event includes five or more parameters selected from the group consisting of outer source IP address, the outer destination IP address, the outer protocol, the ESP protocol, the inner source IP address, the inner destination IP address, the inner protocol, the source port, the destination port, a security payload index, a decryption algorithm, and a decryption key.

12. An article comprising a machine-accessible medium having associated data, wherein the data, when accessed, results in a machine performing the following operations:
receive from a security endpoint a security information event that includes rules for decrypting or routing an encrypted packet;
respond to the security endpoint with a query when the security information event does not provide the information necessary for a network device to route the encrypted packet; and
receive from the security endpoint additional security information for decrypting or routing an encrypted packet.

13. The article of claim 12, further comprising instructions to receive a security information event including security information for a secure Internet protocol.

14. The article of claim 12, further comprising instructions to receive a security information event that includes a Security Information Transport Protocol mapping table.

15. The article of claim 12, further comprising instructions to receive an information event which includes five or more parameters selected from the group consisting of outer source IP address, the outer destination IP address, ESP protocol, a security payload index, a decryption algorithm, and a decryption key.

16. The article of claim 12, wherein the instructions are embedded in a device in an open network.

17. The article of claim 16, wherein the instructions and a routing element reside on the same platform.

18. The article of claim 12, further comprising instructions to receive a security information event compromised of information received in multiple transmissions.

19. A flow control method comprising:
receiving a security information event from a security endpoint that includes rules for decrypting or routing an encrypted packet;
responding to the security endpoint with a query when the security information event does not provide the information necessary for a network device to route the encrypted packet; and
receiving from the security endpoint additional security information for decrypting or routing an encrypted packet.

20. The method of claim 19, wherein the security information event includes security information for a secure Internet protocol.

21. The method of claim 19, wherein the security information event includes a Security Information Transport Protocol mapping table.

22. The method of claim 19, wherein the security information event includes five or more parameters selected from the group consisting of outer source IP address, the outer destination IP address, ESP protocol, a security payload index, a decryption algorithm, and a decryption key.

23. The method of claim 12, wherein the security information event is sent by a device in an open network.

24. The article of claim 12, wherein the security information event is received in multiple transmissions.
